(19) United States
(12) Patent Application Publication
(10) Pub. No.: US 2024/0052538 A1
(43) Pub. Date: Feb. 15, 2024

(54) Composite Wipes and Fabrication Method Therefor

(71) Applicant: XIAMEN YANJAN NEW MATERIAL CO., LTD., Fujian (CN)

(72) Inventors: Shihuang LI, Fujian (CN); Qingzhong ZHENG, Fujian (CN); Xingxing LIU, Fujian (CN); Danpin WU, Fujian (CN); Jihua XIE, Fujian (CN)

(21) Appl. No.: 18/270,737

(22) PCT Filed: Jan. 10, 2022
(86) PCT No.: PCT/CN2022/070907

§ 371 Date: Jul. 3, 2023

(30) Foreign Application Priority Data
Jan. 11, 2021 (CN) 202110030694.3

(51) Int. Cl. D04H 5/06; A47K 10/16; D01F 8/02

(52) U.S. Cl. CPC D04H 5/06; A47K 10/16; D01F 8/02; D10B 2201/01

(57) ABSTRACT

Composite wipes (17, 27, 37) and a fabrication method therefor. Upper surface layers and lower surface layers of the composite wipes (17, 27, 37) are melt-blown fiber mesh (13, 14, 23, 24, 33, 34), intermediate layers of the composite wipes (17, 27, 37) are wood pulp fiber mesh (12, 22, 32), and spunbonded long fiber mesh (15, 25, 35, 35′) composed of spunbonded long fibers are provided between the melt-blown fiber mesh (13, 14, 23, 24, 33, 34) of the upper and/or lower surface layers and the wood pulp fiber mesh (12, 22, 32), and melt-blown short fibers in the melt-blown fiber mesh (13, 14, 23, 24, 33, 34) of the upper and lower surface layers are interwoven into adjoining spunbonded long fiber mesh (15, 25, 35, 35′) or wood pulp fiber mesh (12, 22, 32).

### BACKGROUND OF THE INVENTION

The present invention relates to wipe technology and more particularly pertains to a composite wipe for personal and infant care having increased mechanical strength and which prevents fiber detachment from the wipe. A manufacturing method therefor is also disclosed.

Wipes are very convenient to carry, store and use, so they are very popular among vast consumers. Wipes are commonly used in daily life, such as when a parent replaces a diaper, or when dining in a restaurant, or during cosmetic skin care. It is obvious that wipes are more and more widely applied in personal and infant care. Wipes may be made of spunlace nonwoven fabric or meltblown composite nonwoven fabric. In comparison with traditional wipes made of cloth, such wipes are convenient to manufacture, low in price, and can be used in dry and wet.

However, meltblown composite nonwoven fabric in the prior art has two surface layers each being a meltblown fiber layer, compounded with a sandwiched layer being a wood pulp fiber layer in between the two surface layers. Since wood pulp fibers of the wood pulp fiber layer are generally shorter (staple fibers), they may be easily fall off from the two surface layers, causing the problem of fiber detachment as mentioned above. Further, each meltblown fiber layer is formed by a meltblown fiber web, and meltblown fibers in the meltblown fiber web are also short fibers (staple fibers), therefore, when the meltblown fibers are consolidated, the meltblown fiber layer being formed has a relatively low mechanical strength which affects the general mechanical strength of a wipe made of meltblown composite nonwoven fabric.

### BRIEF SUMMARY OF THE INVENTION

To overcome the shortcomings of existing products and manufacturing methods, the present invention provides a composite wipe having increased mechanical strength and which effectively prevents fiber detachment from the wipe, and also a manufacturing method therefor.

To attain this, the present invention adopts the following technical solutions:

A composite wipe, comprising an upper layer and a lower layer being meltblown fiber webs respectively, and a middle layer being a wood pulp fiber web; wherein a spunbond filament web formed by spunbond filaments is present between the wood pulp fiber web and the upper layer and/or between the wood pulp fiber web and the lower layer; meltblown staples of the meltblown fiber web forming the upper layer and/or the meltblown fiber web forming the lower layer are intertwined with the adjacent spunbond filament web and/or the wood pulp fiber web.

Each of the spunbond filaments is a single component spunbond filament, a bi-component spunbond filament, or a mixture of both the single component spunbond filament and the bi-component spunbond filament.

The spunbond filament web has a weight of 2-20 g/m².

Each of the meltblown staples of the upper layer and the lower layer is a single component meltblown staple, a bi-component meltblown staple, or a mixture of both the single component meltblown staple and the bi-component meltblown staple.

Each of the meltblown staples has a fiber diameter smaller than or equal to 10 μm.

The bi-component meltblown staple and the bi-component spunbond filament each comprises a first resin and a second resin; the first resin has a melting point which is higher than a melting point of the second resin by more than 20° C.; and a surface of each bi-component meltblown staple and a surface of each bi-component spunbond filament consists at least partially of the second resin which has a lower melting point; the bi-component meltblown staple and the bi-component spunbond filament are each structured as a bi-component sheath-core type, or a bi-component orange peel type, or a bi-component side-by-side type.

A weight percentage of the wood pulp fiber web with respect to a total weight of the composite wipe is more than 50%.

The weight percentage of the wood pulp fiber web with respect to the total weight of the composite wipe is 65%-80%.

A manufacturing method for a composite wipe, comprising the following steps:
(1) Wood pulp is opened and loosened by an opening roller and then passes through a spray pipe under action of an auxiliary air flow to form a wood pulp fiber web;
(2) by meltblown technology, at least one thermoplastic resin is heated and thereafter input to meltblown spinnerets after being melted; melt trickles of said at least one thermoplastic resin exit from nozzles of the meltblown spinnerets are blown into fiber bundles being meltblown staples with fiber diameter smaller than or equal to 10 μm by hot air flow, thereby forming meltblown fiber webs with the hot air flow;
(3) by spunbond technology, at least one thermoplastic resin is heated and thereafter input to at least one spunbond spinneret after being melted; heated and melted said at least one thermoplastic resin in said at least one spunbond spinneret is formed as melt trickles in said at least one spunbond spinneret, and then the melt trickles exit from nozzles of said at least one spunbond spinneret, cooled by at least one side-blown cold air to form spunbond filaments; and then the spunbond filaments are drawn by at least one fiber drawing device, thereby forming at least one spunbond filament web;
(4) the meltblown fiber webs join adjacently to a side surface of the wood pulp fiber web and a side surface of each of said at least one spunbond filament web respectively, so as to form a multi-layer structural fiber web with the meltblown fiber webs at two sides of the multi-layer structural fiber web and the wood pulp fiber web and said at least one spunbond filament web in a middle of the multi-layer structural fiber web;
(5) fiber webs of the multi-layer structural fiber web are consolidated together by passing through a heating device to form a composite wipe with an upper layer and a lower layer being the meltblown fiber webs and a middle layer comprising the wood pulp fiber web and said at least one spunbond filament web.

Said nozzles of the meltblown spinnerets and said nozzles of said at least one spunbond spinneret are in each case being arranged as single component nozzles, bi-component nozzles, or a mixture of single component nozzles and bi-component nozzles.

Each of the bi-component nozzles is structured as bi-component sheath-core type, or a bi-component orange peel type, or a bi-component side-by-side type.

The heating device is a hot air oven, hot rollers, or mixture of both.

The present invention has the following beneficial advantages:

By using the above technical solutions, at least one spunbond filament web is present between the wood pulp fiber web and the meltblown fiber web of the upper layer and/or the meltblown fiber web of the lower layer. During manufacture, meltblown staples of the meltblown fiber webs are partially intertwined with the adjacent spunbond filament web and/or the wood pulp fiber web to form a multi-layer structural fiber web. When the multi-layer structural fiber web passes through a heating device to be treated by the heating device, an intertwined web structure is formed in the resulting composite wipe where the meltblown fiber webs are adhered with said at least one spunbond filament web and the wood pulp fiber web, so that staple fibers of the wood pulp fiber web are difficult to move, thereby preventing fiber detachment of the composite wipe during use, and also effectively preventing staple fibers of the wood pulp fiber web from gathering together when they are soaked with liquid used together with the composite wipe. Further, because said at least one spunbond filament web is formed by spunbond filaments which have a far greater mechanical strength than meltblown staples, the composite wipe resulted from consolidation of the fiber webs has increased mechanical strength, thereby solving the problem of easy tearing of the wipe due to low mechanical strength.

### BRIEF DESCRIPTION OF THE DRAWINGS

FIG. 1 is a schematic view of the manufacture of the composite wipe of Embodiment 1 of the present invention.

FIG. 2 is a sectional view of the composite wipe of Embodiment 1 of the present invention.

FIG. 3 is a schematic view of the manufacture of the composite wipe of Embodiment 2 of the present invention.

FIG. 4 is a sectional view of the composite wipe of Embodiment 2 of the present invention.

FIG. 5A is a sectional view of the sheath-core type bi-component fibers of the present invention.

FIG. 5B is a sectional view of the bi-component side-by-side type bi-component fibers of the present invention.

FIG. 5C is a sectional view of the bi-component orange peel type bi-component fibers of the present invention.

FIG. 6 is a schematic view of the manufacture of the composite wipe of Embodiment 3 of the present invention.

FIG. 7 is a sectional view of the composite wipe of Embodiment 3 of the present invention.

### REFERENCE SIGNS IN THE FIGURES

Embodiment 1: Wood pulp 11; Wood pulp fiber web 12; Meltblown fiber webs 13, 14; Spunbond fiber web 15; Multi-layer structural fiber web 16; Composite wipe 17; Opening roller A1; Spray pipe B1; Meltblown spinnerets C1, C1′; Spunbond spinneret D1; Side-blown cold air E1; Fiber drawing device F1; Hot rollers G1.

Embodiment 2: Wood pulp 21; Wood pulp fiber web 22; Meltblown fiber webs 23, 24; Spunbond fiber web 25; Multi-layer structural fiber web 26; Composite wipe 27; Opening roller A2; Spray pipe B2; Meltblown spinnerets C2, C2; Spunbond spinneret D2; Side-blown cold air E2; Fiber drawing device F2; Hot air oven H2; Sheath-core type bi-component fibers 28; Bi-component side-by-side type bi-component fibers 29; Bi-component orange peel type bi-component fibers 30; Core layer resin 28a; Sheath layer resin 28b; First resin 29a, 30a; Second resin 29b, 30b.

Embodiment 3: Wood pulp 31; Wood pulp fiber web 32; Meltblown fiber webs 33, 34; First spunbond fiber web 35; Second spunbond fiber web 35′; Multi-layer structural fiber web 36; Composite wipe 37; Opening roller A3; Spray pipe B3; Meltblown spinnerets C3, C3′; First spunbond spinneret D3; Second spunbond spinneret D3′; First side-blown cold air E3; Second side-blown cold air E3′; First fiber drawing device F3; Second fiber drawing device F3′; Hot air oven H3; Hot rollers G3.

### DETAILED DESCRIPTION OF THE INVENTION

In order to further explain the technical solutions of the present invention, the present invention is described in details with reference to specific embodiments.

### Embodiment 1

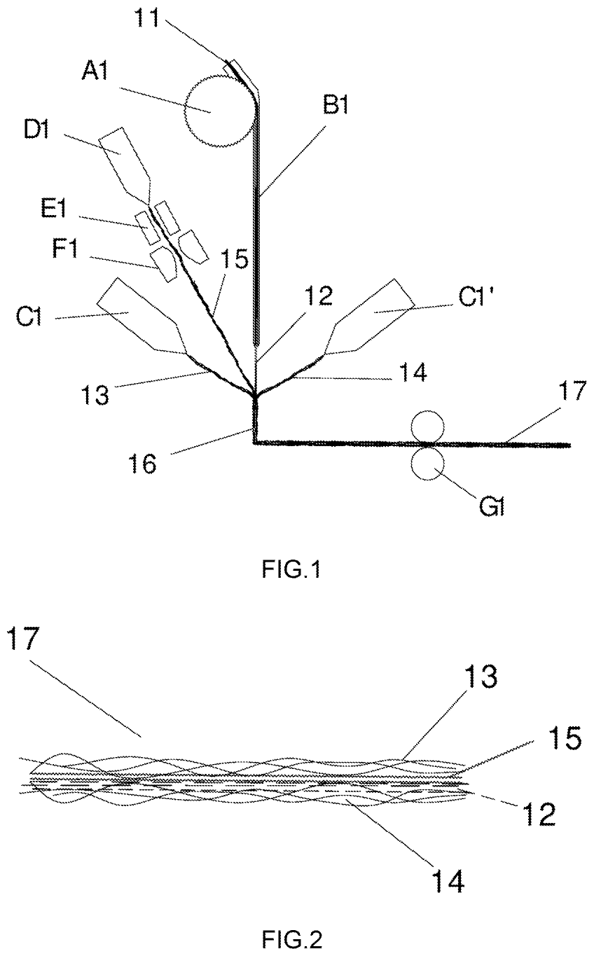

As shown in FIG. 1, the present invention discloses a manufacturing method for a composite wipe comprising the following steps:
(1) Wood pulp 11 is opened and loosened by an opening roller A1 and then passes through a spray pipe B1 under action of an auxiliary air flow to form a wood pulp fiber web 12;
(2) by meltblown technology, thermoplastic resin being polypropylene (PP) is heated and thereafter input to meltblown spinnerets C1, C1′ after being melted; melt trickles of the thermoplastic resin exit from nozzles of the meltblown spinnerets C1, C1′ are blown into fiber bundles being meltblown staples with fiber diameter smaller than or equal to 10 μm by hot air flow, thereby forming meltblown fiber webs 13, 14 with the hot air flow;
(3) by spunbond technology, thermoplastic resin being polypropylene (PP) is heated and thereafter input to a spunbond spinneret D1 after being melted; heated and melted thermoplastic resin in the spunbond spinneret D1 is formed as melt trickles in the spunbond spinneret D1, and then the melt trickles exit from nozzles of the spunbond spinneret D1, cooled by side-blown cold air E1 to form spunbond filaments (long and continuous fibers); and then the spunbond filaments are drawn by a fiber drawing device F1, thereby forming a spunbond filament web 15;
(4) the meltblown fiber webs 13, 14 join adjacently to a side surface of the wood pulp fiber web 12 and a side surface of the spunbond filament web 15 respectively, so as to form a multi-layer structural fiber web 16 with the meltblown fiber webs 13, 14 at two sides of the multi-layer structural fiber web 16 and the wood pulp fiber web 12 and the spunbond filament web 15 in a middle of the multi-layer structural fiber web 16;
(5) fiber webs of the multi-layer structural fiber web 16 are consolidated together by passing through hot rollers G1 to form a composite wipe 17 with an upper layer and a lower layer being the meltblown fiber webs 13, 14 and a middle layer comprising the wood pulp fiber web 12 and the spunbond filament web 15.

As shown in FIG. 2, the present invention also discloses a composite wipe 17 manufactured by the aforementioned manufacturing method for a composite wipe. The composite wipe 17 has an upper layer and a lower layer being the meltblown fiber webs 13, 14 and a middle layer being the wood pulp fiber web 12. Additionally, the spunbond filament web 15 formed by spunbond filaments is present between the wood pulp fiber web 12 and the upper layer/the lower layer. Of course, the spunbond filament web 15 may be present between the wood pulp fiber web 12 and the upper layer, as well as between the wood pulp fiber web 12 and the lower layer. Meltblown staples (short fibers) of the meltblown fiber web 13 forming the upper layer and/or the meltblown fiber web 14 forming the lower layer are partially intertwined with the adjacent spunbond filament web 15 and/or the wood pulp fiber web 12.

The spunbond filament web 15 has a weight of 2-20 g/m². In this embodiment, the spunbond filament web 15 has a weight of 10 g/m². A weight percentage of the wood pulp fiber web 12 with respect to a total weight of the composite wipe 17 is more than 50%, and most preferably 65%-80%. In this embodiment, the weight percentage of the wood pulp fiber web 12 with respect to the total weight of the composite wipe 17 is 70%.

By using the above technical solutions, due to the presence of the spunbond filament web 15, meltblown staples of the meltblown fiber webs 13, 14 are partially intertwined with the adjacent spunbond filament web 15 and/or the wood pulp fiber web 12. After the multi-layer structural fiber web 16 passes through the hot rollers G1, an intertwined web structure is formed in the resulting composite wipe 17, where staple fibers of the wood pulp fiber web 12 are difficult to move, thereby preventing fiber detachment of the composite wipe 17 during use, and also effectively preventing staple fibers of the wood pulp fiber web 12 from gathering together when they are soaked with liquid used together with the composite wipe 17. Further, because the spunbond filament web 15 is formed by spunbond filaments which have a far greater mechanical strength than meltblown staples, the problem of easy tearing of the wipe due to low mechanical strength is solved.

### Embodiment 2

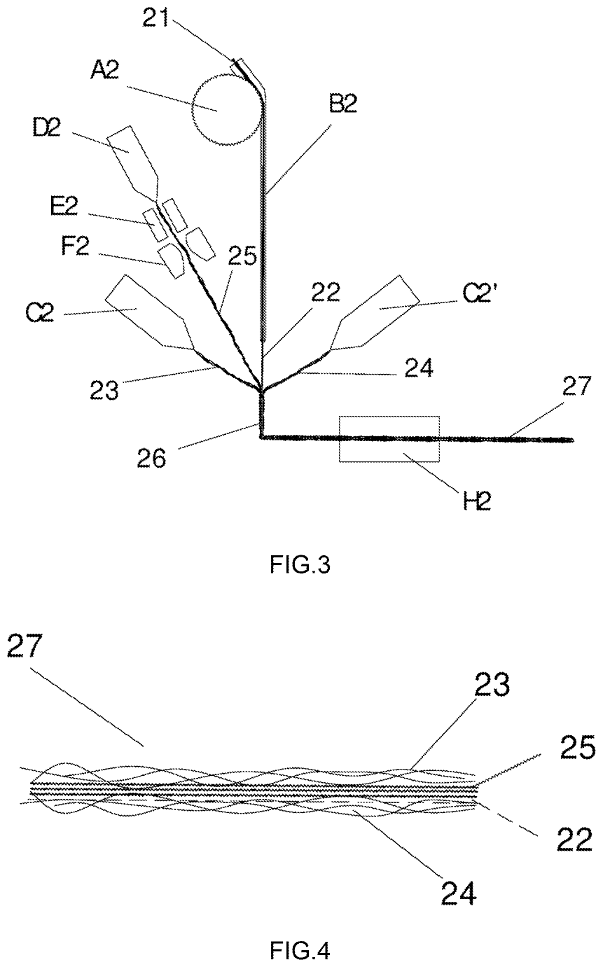

As shown in FIG. 3, the present invention discloses a manufacturing method for a composite wipe comprising the following steps:
(1) Wood pulp 21 is opened and loosened by an opening roller A2 and then passes through a spray pipe B2 under action of an auxiliary air flow to form a wood pulp fiber web 22;
(2) by meltblown technology, thermoplastic resin being polypropylene (PP) and thermoplastic resin being high density polyethylene (HDPE) are heated, and then both thermoplastic resins are input to each of meltblown spinnerets C2, C2′ after being melted; melt trickles of the thermoplastic resins exit from bi-component nozzles of both the meltblown spinnerets C2, C2′ are blown into fiber bundles being meltblown staples with fiber diameter smaller than or equal to 10 μm by hot air flow, thereby forming meltblown fiber webs 23, 24 with the hot air flow, wherein each of the meltblown fiber webs 23, 24 is formed by bi-component meltblown staples each formed from both polypropylene (PP) and high density polyethylene (HDPE), and wherein a surface of each of the bi-component meltblown staples consists at least partially of said high density polyethylene (HDPE);
(3) by spunbond technology, thermoplastic resin being polypropylene (PP) and thermoplastic resin being high density polyethylene (HDPE) are heated and thereafter input to a spunbond spinneret D2 after being melted; heated and melted thermoplastic resins in the spunbond spinneret D2 are formed as melt trickles in the spunbond spinneret D2, and then the melt trickles exit from bi-component nozzles of the spunbond spinneret D2, cooled by side-blown cold air E2 to form spunbond filaments; and then the spunbond filaments are drawn by a fiber drawing device F2, thereby forming a spunbond filament web 25; wherein the spunbond filaments are bi-component spunbond filaments each formed from both polypropylene (PP) and high density polyethylene (HDPE), and wherein a surface of each of the bi-component spunbond filaments consists at least partially of said high density polyethylene (HDPE);
(4) the meltblown fiber webs 23, 24 join adjacently to a side surface of the wood pulp fiber web 12 and a side surface of the spunbond filament web 15 respectively, so as to form a multi-layer structural fiber web 26 with the meltblown fiber webs 23, 24 at two sides of the multi-layer structural fiber web 26 and the wood pulp fiber web 22 and the spunbond filament web 25 in a middle of the multi-layer structural fiber web 26;
(5) fiber webs of the multi-layer structural fiber web 26 are consolidated together by passing through a hot air oven H2 to form a composite wipe 27 with an upper layer and a lower layer being the meltblown fiber webs 23, 24 and a middle layer comprising the wood pulp fiber web 22 and the spunbond filament web 25.

As shown in FIG. 4, the present invention also discloses a composite wipe 27 manufactured by the aforementioned manufacturing method for a composite wipe. The composite wipe 27 has an upper layer and a lower layer being the meltblown fiber webs 23, 24 and a middle layer being the wood pulp fiber web 22. Additionally, the spunbond filament web 25 formed by spunbond filaments is present between the wood pulp fiber web 22 and the upper layer/the lower layer. Of course, the spunbond filament web 25 may be present between the wood pulp fiber web 22 and the upper layer, as well as between the wood pulp fiber web 22 and the lower layer. Meltblown staples of the meltblown fiber web 23 forming the upper layer and/or the meltblown fiber web 24 forming the lower layer are partially intertwined with the adjacent spunbond filament web 25 and/or the wood pulp fiber web 22.

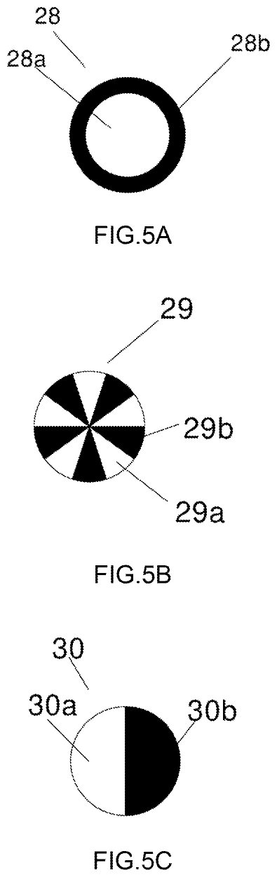

A weight percentage of the wood pulp fiber web 22 with respect to a total weight of the composite wipe 27 is more than 50%, and most preferably 65%-80%. In this embodiment, the weight percentage of the wood pulp fiber web 22 with respect to the total weight of the composite wipe 27 is 70%. The spunbond filament web 25 has a weight of 2-20 g/m². In this embodiment, the spunbond filament web 25 has a weight of 15 g/m². Each of the bi-component meltblown staples and each of the bi-component spunbond filaments are each structured as bi-component sheath-core type 28 as shown in FIG. 5A (where a core layer resin 28a is PP, and a sheath layer resin 28b is HDPE, and melting points of PP and HDPE are different from each other by more than 20° C.), or bi-component orange peel type 29 as shown in FIG. 5B (where a first resin 29a is PP, and a second resin 29b is HDPE, and melting points of PP and HDPE are different from each other by more than 20° C.), or bi-component side-by-side type 30 as show in FIG. 5C (where a first resin 30a is PP, and a second resin 30b is HDPE, and melting points of PP and HDPE are different from each other by more than 20° C.).

By using the above technical solutions, since the spunbond fiber web 25 and both the meltblown fiber webs 23, 24 are each being formed from bi-component fibers, while two fibers have melting points different from each other by more than 20° C., and a surface of each of each type of bi-component fibers contains at least partially of low melting point resin (which is HDPE), when the multi-layer structural fiber web 26 passes through the hot air oven H2, the low melting point resin on the surface of each of the bi-component meltblown staples and the surface of each of the bi-component spunbond filaments starts to melt so that fibers are mutually adhered together; further, the bi-component meltblown staples of the meltblown fiber webs 23, 24 are partially intertwined with the adjacent spunbond filament web 25 and/or the wood pulp fiber web 22, resulting in an intertwined web structure in the resulting composite wipe 27, where staple fibers of the wood pulp fiber web 22 are difficult to move, thereby preventing fiber detachment of the composite wipe 27 during use, and also effectively preventing staple fibers of the wood pulp fiber web 22 from gathering together when they are soaked with liquid used together with the composite wipe 27. Further, because the spunbond filament web 25 is formed by spunbond filaments which have a far greater mechanical strength than meltblown staples, the problem of easy tearing of the wipe due to low mechanical strength is solved.

### Embodiment 3

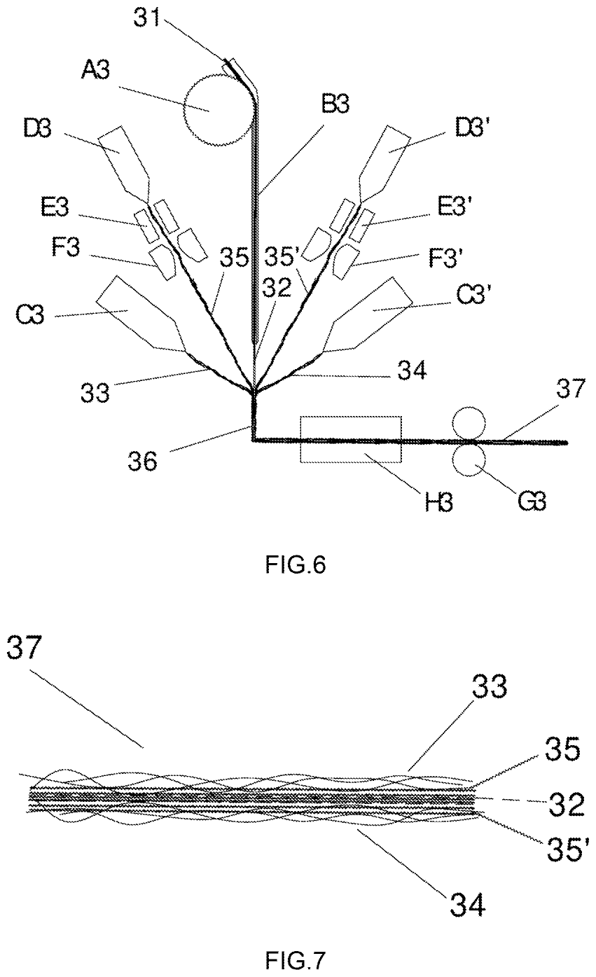

As shown in FIGS. 6-7, the present invention discloses a manufacturing method for a composite wipe, and a composite wipe 37 made by such manufacturing method. The manufacturing method comprises the following steps:
(1) Wood pulp 31 is opened and loosened by an opening roller A3 and then passes through a spray pipe B3 under action of an auxiliary air flow to form a wood pulp fiber web 32;
(2) by meltblown technology, thermoplastic resin being polypropylene (PP) and thermoplastic resin being high density polyethylene (HDPE) are heated, and then both thermoplastic resins are input to each of meltblown spinnerets C3, C3′ after being melted; melt trickles of the thermoplastic resins exit from bi-component nozzles of both the meltblown spinnerets C2, C2′ are blown into fiber bundles being meltblown staples with fiber diameter smaller than or equal to 10 μm by hot air flow, thereby forming meltblown fiber webs 33, 34 with the hot air flow, wherein each of the meltblown fiber webs 33, 34 is formed by bi-component meltblown staples each formed from both polypropylene (PP) and high density polyethylene (HDPE), and wherein a surface of each of the bi-component meltblown staples consists at least partially of said high density polyethylene (HDPE);
(3) by spunbond technology, thermoplastic resin being polypropylene (PP) is heated and thereafter input to a first spunbond spinneret D3 after being melted; heated and melted thermoplastic resin in the first spunbond spinneret D3 is formed as melt trickles in the first spunbond spinneret D3, and then the melt trickles exit from nozzles of the first spunbond spinneret D3, cooled by a first side-blown cold air E3 to form first spunbond filaments; and then the first spunbond filaments are drawn by a first fiber drawing device F3, thereby forming a first spunbond filament web 35;
(4) by spunbond technology, thermoplastic resin being polypropylene (PP) is heated and thereafter input to a second spunbond spinneret D3′ after being melted; heated and melted thermoplastic resin in the second spunbond spinneret D3′ is formed as melt trickles in the second spunbond spinneret D3′, and then the melt trickles exit from nozzles of the second spunbond spinneret D3′, cooled by a second side-blown cold air E3′ to form second spunbond filaments; and then the second spunbond filaments are drawn by the second fiber drawing device F3′, thereby forming a second spunbond filament web 35′;
(5) the meltblown fiber webs 33, 34 intertwine with at least one side surface of the wood pulp fiber web 32, at least one side surface of the first spunbond filament web 35, and at least one side surface of the second spunbond filament web 35′, so as to form a multi-layer structural fiber web 36 with the meltblown fiber webs 33, 34 at two sides of the multi-layer structural fiber web 16 and a middle layer in between the two sides, wherein the middle layer comprises the first spunbond filament web 35 and the second spunbond filament web 35′ at two sides of the middle layer and the wood pulp fiber web 32 in a middle of the middle layer between the first spunbond filament web 35 and the second spunbond filament web 35′;
(6) fiber webs of the multi-layer structural fiber web 36 are consolidated together by passing through a hot air oven H3 and between hot rollers G3 to form a composite wipe 37 (as shown in FIG. 7) with an upper layer and a lower layer being the meltblown fiber webs 33, 34 and a middle layer comprising the first spunbond filament web 35 and the second spunbond filament web 35′ at two sides and the wood pulp fiber web 32 in a middle of the middle layer between the first spunbond filament web 35 and the second spunbond filament web 35′. A weight percentage of the wood pulp fiber web 32 with respect to a total weight of the composite wipe 37 is 80%. Each of the first spunbond filament web 35 and the second spunbond filament web 35′ has a weight of 20 g/m².

By using the above technical solutions, since both the meltblown fiber webs 33, 34 are each being formed from bi-component meltblown staples, while two fibers in each of the bi-component meltblown staples have melting points different from each other by more than 20° C., and a surface of each of the bi-component meltblown staples contains at least partially the low melting point resin (which is HDPE), when the multi-layer structural fiber web 36 passes through the hot air oven H3, the low melting point resin on the surface of each of the bi-component meltblown staples starts to melt, so that fibers are mutually adhered together; further, due to the presence of the first spunbond fiber web 35 and the second spunbond fiber web 35′ which are adhere the meltblown fiber webs 33, 34 and the wood pulp fiber web 32 together, and when they are passed between the hot rollers G3, an intertwined web structure is formed in the resulting composite wipe 27, where staple fibers of the wood pulp fiber web 32 are difficult to move within such intertwined web structure of the meltblown fiber webs 33, 34, the first spunbond fiber web 35 and the second spunbond fiber web 35′, intertwined with the staple fibers of the wood pulp fiber web 32, thereby preventing fiber detachment of the composite wipe 37 during use, and also effectively preventing staple fibers of the wood pulp fiber web 32 from gathering together when they are soaked with liquid used together with the composite wipe 37.

1. A composite wipe, comprising an upper layer and a lower layer being meltblown fiber webs respectively, and a middle layer being a wood pulp fiber web; wherein a spunbond filament web formed by spunbond filaments is present between the wood pulp fiber web and the upper layer and/or between the wood pulp fiber web and the lower layer; meltblown staples of the meltblown fiber web forming the upper layer and/or the meltblown fiber web forming the lower layer are intertwined with the adjacent spunbond filament web and/or the wood pulp fiber web.

2. The composite wipe of claim 1, wherein each of the spunbond filaments is a single component spunbond filament, a bi-component spunbond filament, or a mixture of both the single component spunbond filament and the bi-component spunbond filament.

3. The composite wipe of claim 2, wherein the bi-component spunbond filament comprises a first resin and a second resin; the first resin has a melting point which is higher than a melting point of the second resin by more than 20° C.; and a surface of the bi-component spunbond filament consists at least partially of the second resin which has a lower melting point; the bi-component spunbond filament is structured as a bi-component sheath-core type, or a bi-component orange peel type, or a bi-component side-by-side type.

4. The composite wipe of claim 1, wherein the spunbond filament web has a weight of 2-20 g/m².

5. The composite wipe of claim 1, wherein each of the meltblown staples of the upper layer and the lower layer is a single component meltblown staple, a bi-component meltblown staple, or a mixture of both the single component meltblown staple and the bi-component meltblown staple.

6. The composite wipe of claim 5, wherein the bi-component meltblown staple comprises a first resin and a second resin; the first resin has a melting point which is higher than a melting point of the second resin by more than 20° C.; and a surface of the bi-component meltblown staple consists at least partially of the second resin which has a lower melting point; the bi-component meltblown staple is structured as a bi-component sheath-core type, or a bi-component orange peel type, or a bi-component side-by-side type.

7. The composite wipe of claim 1, wherein each of the meltblown staples has a fiber diameter smaller than or equal to 10 μm.

8. The composite wipe of claim 1, wherein a weight percentage of the wood pulp fiber web with respect to a total weight of the composite wipe is more than 50%.

9. The composite wipe of claim 8, wherein the weight percentage of the wood pulp fiber web with respect to the total weight of the composite wipe is 65%-80%.

10. A manufacturing method for a composite wipe, comprising the following steps:
(1) wood pulp is opened and loosened by an opening roller and then passes through a spray pipe under action of an auxiliary air flow to form a wood pulp fiber web;
(2) by meltblown technology, at least one thermoplastic resin is heated and thereafter input to meltblown spinnerets after being melted; melt trickles of said at least one thermoplastic resin exit from nozzles of the meltblown spinnerets are blown into fiber bundles being meltblown staples with fiber diameter smaller than or equal to 10 μm by hot air flow, thereby forming meltblown fiber webs with the hot air flow;
(3) by spunbond technology, at least one thermoplastic resin is heated and thereafter input to at least one spunbond spinneret after being melted; heated and melted said at least one thermoplastic resin in said at least one spunbond spinneret is formed as melt trickles in said at least one spunbond spinneret, and then the melt trickles exit from nozzles of said at least one spunbond spinneret, cooled by at least one side-blown cold air to form spunbond filaments; and then the spunbond filaments are drawn by at least one fiber drawing device, thereby forming at least one spunbond filament web;
(4) the meltblown fiber webs join adjacently to a side surface of the wood pulp fiber web and a side surface of each of said at least one spunbond filament web respectively, so as to form a multi-layer structural fiber web with the meltblown fiber webs at two sides of the multi-layer structural fiber web and the wood pulp fiber web and said at least one spunbond filament web in a middle of the multi-layer structural fiber web;
(5) fiber webs of the multi-layer structural fiber web are consolidated together by passing through a heating device to form a composite wipe with an upper layer and a lower layer being the meltblown fiber webs and a middle layer comprising the wood pulp fiber web and said at least one spunbond filament web.

11. The manufacturing method of claim 10, wherein said nozzles of the meltblown spinnerets and said nozzles of said at least one spunbond spinneret are in each case being structured as single component nozzles, bi-component nozzles, or a mixture of single component nozzles and bi-component nozzles.

12. The manufacturing method of claim 11, wherein each of the bi-component nozzles is structured as bi-component sheath-core type, or a bi-component orange peel type, or a bi-component side-by-side type.

13. The manufacturing method of claim 10, wherein the heating device is a hot air oven, hot rollers, or mixture of both.
